(19) United States
(12) Patent Application Publication
(10) Pub. No.: US 2025/0108725 A1
(43) Pub. Date: Apr. 3, 2025

(54) TIME RESOLVED IMPEDANCE SPECTROSCOPY FOR BATTERY SOFT-SHORT DETECTION

(71) Applicant: UT-Battelle, LLC, Oak Ridge, TN (US)

(72) Inventor: Robert L. Sacci, Knoxville, TN (US)

(21) Appl. No.: 18/783,062

(22) Filed: Jul. 24, 2024

Related U.S. Application Data
(60) Provisional application No. 63/541,180, filed on Sep. 28, 2023.

(51) Int. Cl. B60L 58/16; B60L 53/62; B60L 53/68

(52) U.S. Cl. CPC B60L 58/16; B60L 53/62; B60L 53/68

(57) ABSTRACT

A battery management system that identifies short-circuits during a recharging cycle by identifying data indicative of potential battery failures. The system identifies an unstable operating interval that lies between a healthy and failing battery operating state and labels data within the unstable operating interval to generate a battery profile. The system trains a predictive model by sampling a portion of the battery profile and executes a trained predictive model to render predictions of a battery failure. It executes preventive measures in response to failure predictions during the battery recharging cycle. The battery management system mitigates short-circuits including those caused by lithium dendrites that pierce the separator that isolates the anode from the cathode. Further, the battery management may communicate with local and remote users in response to short-circuit detections.

### 2. PRIORITY CLAIM

This application claims the benefit of priority from U.S. Provisional Application No. 63/541,180, filed Sep. 28, 2023, titled “Time Resolved Impedance Spectroscopy for Battery Soft-Short Detection”, which is incorporated herein by reference.

### 1. STATEMENT REGARDING FEDERALLY SPONSORED RESEARCH AND DEVELOPMENT

These inventions were made with United States government support under Contract No. DE-AC05-00OR22725 awarded by the United States Department of Energy. The United States government has certain rights in the inventions.

### 3. TECHNICAL FIELD

This disclosure relates to battery management, and specifically, to systems that detect soft-short during battery charging cycles.

### 4. RELATED ART

The reliability of batteries is not always reflected in their performance. When a battery is functioning, an impending battery cell failure may go undetected because its deteriorating performance may be insignificant or other battery cells may compensate for losses.

In lithium-ion batteries, lithium ions move from a cathode to an anode during the charging process resulting in a lithium plating. When charging occurs too quickly, lithium deposits grow unevenly from the anode like a flowstone cave forming needle-like structures called lithium dendrites. Soft-short failures occur when lithium dendrites grow long and pierce the separator that isolates the anode from the cathode. Initially, soft-short-circuits created by dendrites may not be robust enough to cause a failure. Instead, the sort-circuits may contribute to elevated battery temperatures and induce capacity loss. In some instances, the accumulation of the sort-circuits causes irreversible battery failures.

Some battery systems do not analyze or estimate battery performance. While some systems detect actual failure conditions, they do not mitigate them. Further, some systems fail to detect symptoms or conditions that precede battery failures and do not prevent battery failures.

### DESCRIPTION OF THE DRAWINGS

The disclosure is better understood with reference to the following drawings and description. The elements in the figures are not necessarily to scale, emphasis instead being placed upon illustrating the principles of the disclosure. Moreover, in the figures, like-referenced numerals designate corresponding parts throughout the different views.

FIG. 1 is a flow diagram of a process that trains predictive models.

FIG. 2 is a flow diagram of a process that forecasts events and executes optional remediations.

FIG. 3 are two exemplary impedance semi-circle like representations of a healthy and failing monitored battery cell or battery pack identifying an unstable interval with respect to radii of the semi-circle like objects.

FIG. 4 are two exemplary impedance semi-circle like representations of a healthy and failing battery cell or battery pack identifying correlated intervals related to their respective states and a conditioned onset interval with respect to radii of the semi-circle like objects of FIG. 3.

FIG. 5 are two exemplary impedance semi-circle like representations of a healthy and failing battery cell or battery pack identifying an unstable interval with respect to centers or midpoints of the semi-circle like objects.

FIG. 6 are two exemplary impedance semi-circle like representations of a healthy and failing battery cell or battery pack identifying correlated intervals related to their respective states and a conditioned onset interval with respect to centers or midpoints of the semi-circle like objects of FIG. 5.

FIG. 7 is a battery management system that forecasts failures and triggers remediation and/or communication.

### DETAILED DESCRIPTION

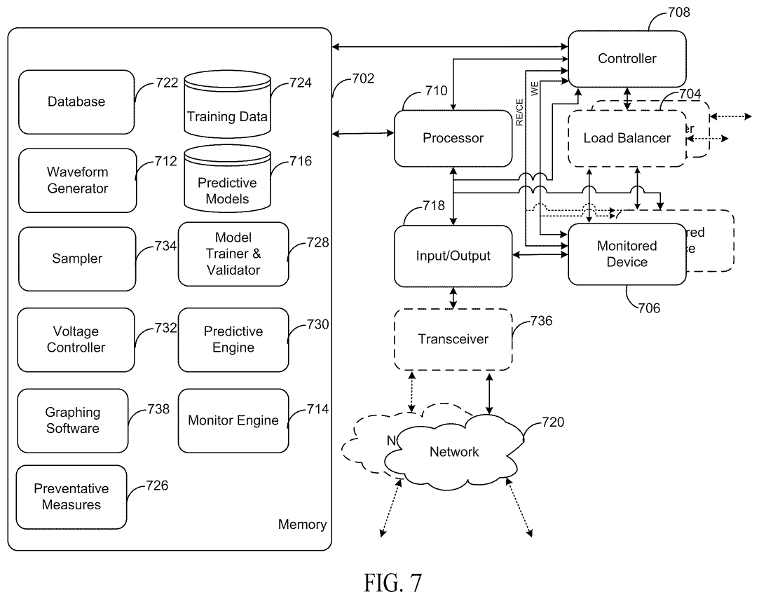

A prognostic system and method (referred to as a prognostic system(s)) automatically enhances the reliability of one, two, or more battery cells, battery packs, and/or battery modules that are individually or collectively monitored and, in this disclosure, referred to as a battery or batteries. The prognostic systems detect operating conditions and symptoms that precede battery failures. Unlike traditional monitoring systems that identify failures after they occur, the prognostic systems predict failures before they occur. The prognostic systems provide predictions, and in some applications, execute preventative measures with lead times that mitigate, and in some applications, prevent failures. Some systems execute preventative measures before a complete or partial failure occurs by scheduling maintenance, lowering the charging rate during the recharging processes, increasing the recharging periods, isolating deteriorating batteries, adjusting battery maintenance, and/or adjusting battery recharging schedules. Some systems execute preventative measures through controllers 708 and optional load balancers 704 shown in FIG. 7 that quarantine or segregate unstable battery cells or battery packs from healthy battery cells or battery packs. Predicting a battery failure with a sufficient lead time to mitigate failure improves a battery's reliability by preventing or minimizing lost capacity, decreases in internal resistance, voltage drops, physical swelling, and the overall decline in battery performance. Accurate predictions and preventative measures maintain optimal and nominal battery states, sustaining longer useful lives by minimizing the likelihood of soft short-circuits caused by the accumulation of dendrites during recharging cycles.

Some prognostic systems process data as it is received to provide real-time or near real-time predictive analysis and, in some systems, real-time mitigation by executing the preventative measures as pre-failure states occur. The terms “real-time” and “real time” are intended to broadly encompass systems that process data at the same rate the systems receive data, enabling the systems to detect pre-failure conditions and/or execute preventative measures like an automatic pilot automatically without manual intervention. Some prognostic systems' analytics predict imminent battery failures.

Some systems analyze and represent the impedance of a battery (i.e., the monitored device 706) in the frequency domain (e.g., spectral domain) or digital domain. In either domain, the real part of a battery's impedance is rendered on an x-coordinate axis and the imaginary part of a battery's impedance is rendered on the y-coordinate axis. Real and reactive impedance and/or other parameters are measured by a controller 708 and a processor 710 or a signal processor. These device via a waveform generator 712 can inject signal frequencies into a charging signal that charges a monitored device 706 while measuring impedance parameters. The signal injections and measurements can occur repeatedly. The complex signals injected into charging signals comprise a synthesized sum of a prime number of sine waves that are combined through superposition as expressed in equation 1 and biased by a voltage controller 732.

$$s ( t ) = {\sum }_{i = 1}^{n} A sin ( 2 π {f}_{i} t + {φ}_{r} ) \qquad Equation l$$

In equation 1, n comprises a natural number greater than one that has no positive divisors other than one and itself, A comprises a constant amplitude, fᵢ comprises a range of arbitrary frequencies, φᵣ comprises a random number of phases, and s(t) comprises the complex alternating current signal (AC signal) in the time domain that may be converted into the frequency domain Z(s) by Laplace transforms. The complex AC signal is injected into a charging direct current during the initial phase of the recharging cycle (e.g., an initial charging period that occurs within the first ten minutes or less in some systems) of the monitored device 706 to predict battery failures.

The impedance characteristics rendered in response to the synthesized signal, renders a substantially continuous contour or arc of output that reflect the battery's impedance across the swept frequencies. In some systems, the gain and phase margins measured by the prognostic system's monitoring engine 714 indicate when a battery is transitioning from a stable state to an unstable state. The battery's impedance response identifies pre-failure conditions that occur during an onset interval that represents a transition between a healthy operating state and a failing operating state.

Because the prognostic system processes predictive models 716 that train on data while the monitored device is operating outside of its designed specifications and data rendered immediately prior to failure, some prognostic systems mitigate system instability regardless of the cause of the instability. Some systems prevent failure without knowing or detecting its cause. Rather, the failure agnostic framework analyzes data to determine if and when batteries are approaching failure. The prognostic systems are different from pattern-matching systems that recognize failures by matching data to historical data of failing devices. Some prognostic systems analyze multiple features and changes (e.g., changing radii, translating centers or midpoints, etc.) and one or more data streams from monitored systems. The monitored systems include charging stations, charging points, charging docks, charging kiosks, electrification stations, electrical vehicles, electronics (e.g., any device that uses electricity), rechargeable devices, mobile/portable devices, and any battery powered device (e.g., including e-readers, smart watches, wireless headphones, tablets, etc.). Through input/output interfaces 718 and networks 720 the prognostic systems communicate with remote destinations and sites by transmitting data/messaging/alerts associated with monitored conditions and forecasts. The communication allows users, original equipment manufacturers (OEMs), insurers, charging network operators/providers, and others to receive data, alerts, and/or histories of one or more monitored device 706.

Some prognostic systems rely on one or more battery profiles to train predictive models 716 that evaluate batteries. The profiles provide granular training data derived from optimal, full, and/or nominal operating states that indicate that a battery is working efficiently, holding its charge within its designed specification, and delivering its expected power without exhibiting symptoms of failure (also referred to as a normal operating state). The profiles further derive granular training data derived before deteriorating battery periods, and/or imminent battery failures that may affect battery capacity, internal resistance, render voltage sags, induce physical swelling, raise battery temperatures, and/or result in an overall decline in battery performance that is stored in memory 724. Further, the prognostic systems may account for disruptive events. Disruptive events generally refer to an unexpected and detectable change in the battery's operating state not associated with the nominal performance of the battery or caused by a failure. It may reflect one or more transient conditions, for example. An exemplary transient condition may comprise a response to a temporary change in a battery's load, a condition that may mistakenly indicate a voltage sag, decrease in resistance, and/or a symptom of an approaching failure in spite of its nominal operation.

The battery profiles may indicate where a failure is expected to occur (e.g., what cells or battery packs), when a failure may occur (e.g., at what point during a charging cycle), and under what load conditions a failure may appear. In response, some prognostic system execute preventative measures 726 that determine when to recondition an at risk battery, how to recondition an at risk battery, how long to recondition an at risk battery, determine whether to reduce loads on an at risk battery, when to isolate an at risk battery and/or when to execute others remediation in accord with the system's protocol and/or operating guidelines.

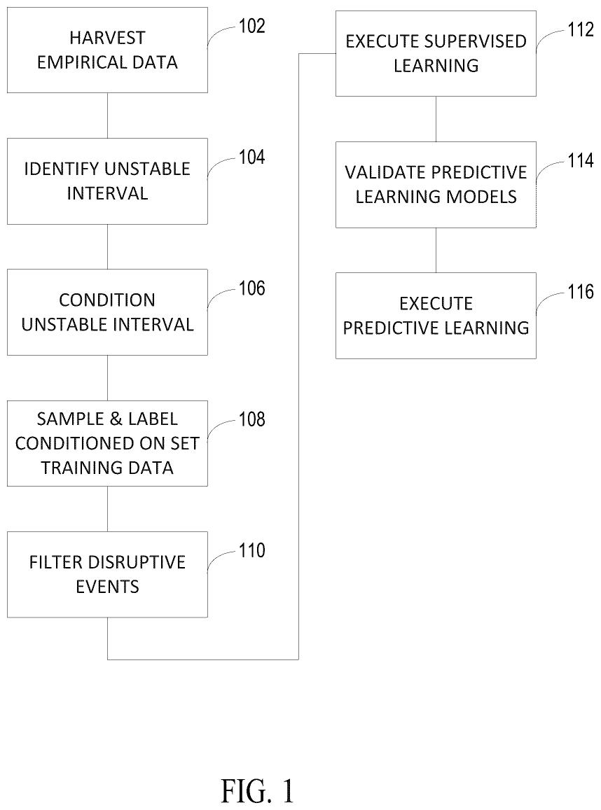

In some systems, the profiles comprise conditioned onset training data sampled from harvested empirical data 102 of FIG. 1 that reflect optimal battery performance, full battery performance, nominal battery performance, and battery performance directly preceding impending battery failures. In these systems, onset intervals and onset training intervals occur between the battery's healthy state and the battery's failure state. A failure detector (e.g., in the form of a monitor engine 714 executed by the controller 708 and/or processor 710) identify and label intervals that identify when a battery failure begins and when an optimal or nominal (e.g., a healthy or normal) operating state ends at 104. These intervals are referred to as unstable operating intervals. In some systems, the unstable operating intervals are conditioned by shortening or removing the outer margins of the intervals at 106. The outer margins are the ranges that directly follow a healthy operating state and directly precede a failing operating state to render a conditioned onset training interval that are sampled at predetermined rates and durations by a sampler 734 and labeled with contextual data that identify the battery condition they represent at 108. While the subsequent and preceding margins removed by the failure detector may strongly predict healthy and failure conditions, they are adjacent to, respectively, the respective margins and may be too closely correlated to the respective associated states to provide actionable predictive data. In some systems, the length of the removed margins are predefined, are of constant or variable length, based on a desired predictive accuracy, based on the lengths of the unstable operating intervals, and/or are established by other criteria for other reasons. Further, to minimize the effect of anomalies and transients that may be mistakenly detected and labeled as a failure condition, some controllers/processors/monitor engines extract and/or exclude data sampled from conditioned onset training intervals associated with and/or occurring in proximity to these occurrences at 110. Disruptive events may occur irregularly and deviate from healthy operating conditions without identifying true failure conditions. By excluding or deleting data associated with disruptive events that do not necessarily represent failure conditions, the systems exclude data from the conditioned onset training intervals that predictive learning models 716 may misinterpret as indicators of impending failures. Further, in some alternative systems, the sample data that comprises the training data that comprise profiles may be further modified so that is tailored to the operating policies of a system or tailored to a desired operating state such as a diagnostic operating state and/or tailored to the age and/or application of the monitored device 706.

Using predictive learning algorithms/models 716 and the sampled data and classifications that comprise the profiles, the prognostic systems identify conditions and/or patterns that are indicative of an impending failure or a pre-failure state (e.g., detectable indicators and/or symptoms that precede an actual failure) through supervised learning by the model trainer and validator 728. Through supervised learning by the model trainer and validator 728, the predictive learning models 716 are trained on a portion of the labeled training data through iterative and repetitive training and testing at 112. The predictive learning models 716 learn from mappings of the desired output associated with the conditioned onset training data stored in memory 724. The predictive learning model predictions are compared to the actual labels of the conditioned onset training data, with the errors used to adjust the predictive learning models. Iterative improvements are made to the predictive learning models based on the comparisons of the identifications rendered by the semi-trained predictive learning models and the labels associated with the onset training data during the training sessions by the model trainer and validator 728. Predictive improvements may comprise adjustments to the weights and biases of the predictive learning models through propagation adjustments. Once trained, the predictive learning models 716 are evaluated using another portion of the conditioned onset training data at 114. If the predictive learning models 716 accurately predict an impending failure or pre-failure state below a predetermined error rate, the trained predictive learning model 716 may be executed by the processor 710 through a predictive engine 730 to identify onset intervals of impending battery failures and/or identify pre-failure states. If the predictive learning models 716 do not accurately predict an impending failure or pre-failure state below a predetermined error rate, the training continues or is repeated. The trained predictive learning models 716 may include support vector machines, convolutional neural networks, decision trees, and/or other passive and regenerative machines, networks, and algorithms.

To identify complete or partial battery failures, some prognostic systems monitor internal resistance of a battery in response to synthesized complex AC signals injected into charging signals used during a charging cycle. Because measurable decreases in internal resistance may be detected during an initial charging period, predictions can be generally rendered in minutes regardless of the charging level. Level 1 charging comprises a slow charging level that may last between about forty and fifty hours. Level 2 charging comprises a mid-level charging level that may last between about four to ten hours. Level 3 charging is a fast charge level that may last about as little as thirty minutes or less.

To detect changes in internal resistance, some prognostic systems synthesize complex charging signals added to direct current charging signals through superposition of a prime number of sine waves that can be translated into the frequency spectrum by Laplace transforms for analytics at 202. Alternately, the prognostic systems may synthesize a predetermined number of fundamental frequencies such as three or four or more fundamental frequencies, such as mixing between forty and fifty or between three to one-hundred fundamental frequencies, for example, at 202. The complex signal may be synthesized by a waveform or a signal generator 712. The fundamental frequencies comprise the lowest frequency of a periodic waveform that is distributed over a broad frequency range, such at least a range of frequencies spanning a factor of ten, for example. The frequencies might range from 20-200 Hz, 200-2,000 Hz, 2,000-20,000 Hz or reflecting a factor of ten, or reflecting three decades or a frequency ranged from about 0.01 Hz-100 kHz, for example. The frequencies may also overlap because of an applied bias or adjustment made through a voltage controller 732 and controller 708 that precisely controls the potential (voltage) applied to a monitored device's working electrode, which is where the reaction of interest may occur (e.g., the anode of a monitored device 706) relative to a reference electrode.

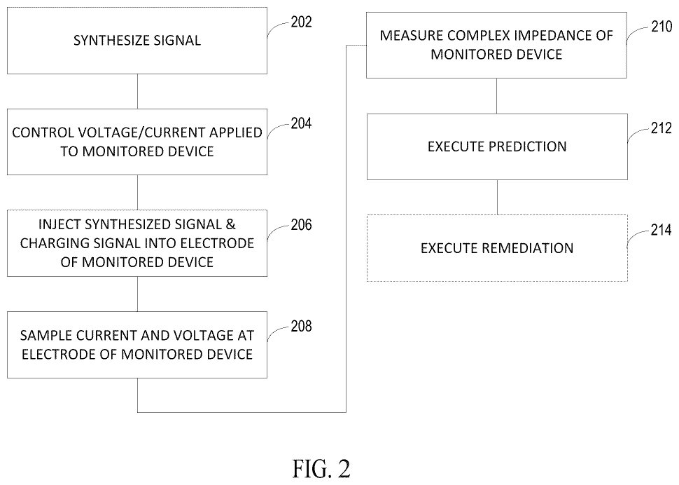

A reference electrode (RE) in a prognostic system serves as the reference point for measuring and controlling a potential or a controlled current applied to the monitored or working electrode (WE) with a counter electrode (CE, e.g., the cathode of a monitored device 706) completing the electrical circuit to the monitored device 706 (e.g., the battery) at 204 shown in FIG. 2. The frequency range is linearly swept between the monitored electrode(s) and reference electrode(s) during a re/charging cycle with the synthesized AC signal from a minimum frequency to a maximum frequency injected into a charging signal at 206. The combinations and injections may be repeated. The resulting current flow between the monitored electrode and reference electrode is repeatedly measured and sampled against the applied voltage and/or controlled current and tracked in time by the sampler 734 and the monitor engine 714 that may include the processor 710 or a digital signal processor at 208. The sampled data collection derives a complex impedance at each frequency point of the swept frequency range by Ohm's law.

$$Z = \frac{V}{I} \qquad Equation 2$$

The complex impedance comprises real (Re(Z)) and imaginary (31 Im(Z)) components in which the real part of the response may be rendered on an x-coordinate axis and the imaginary part of the response on the y-coordinate axis when graphed on a complex impedance plot that may be rendered by a graphing software or graphing circuit 738 at 210. Generally, a two dimensional polar plot comprises a semi-circle like object or arc in the complex plane with differences indicating differences in the electroplating process common to the charging of Lithium based batteries, for example, during an initial period of a charging cycle. Lithium based batteries have Li-based electrolytes that comprise Lithium metals and/or Lithium ions.

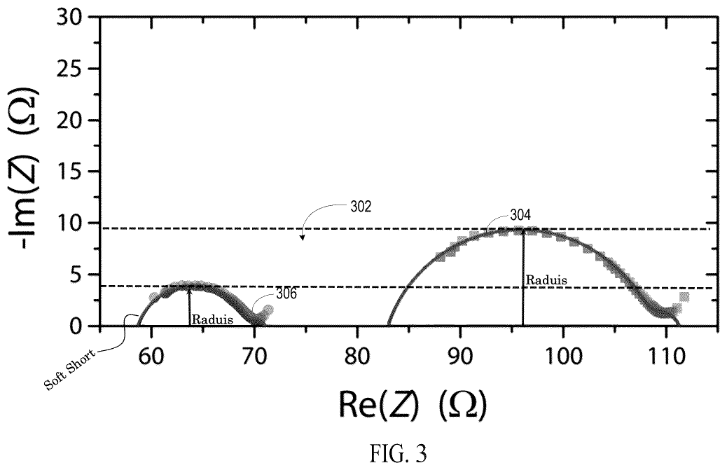

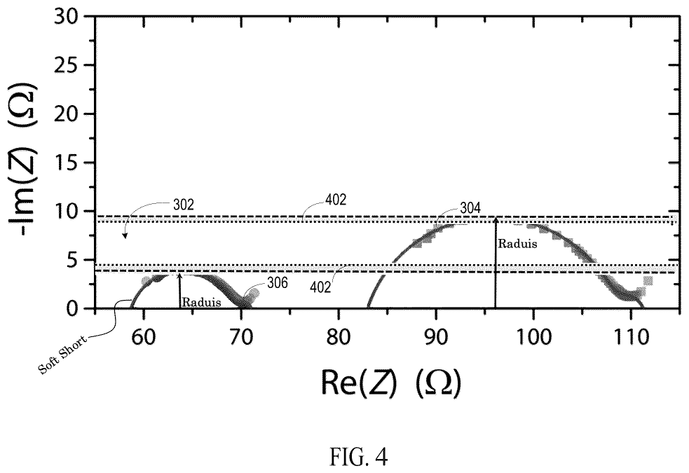

As shown by the exemplary larger arc spanning between about 82 and about 112 Ohms of linear resistance in FIG. 3, an exemplary heathy impedance characteristic has a relatively high resistive component of impedance and a relatively high reactive component of impedance (capacitance and/or inductance) with respect to an exemplary deteriorating impedance state shown by the smaller arc spanning between about 58 and about 72 Ohms of linear resistance shown in FIG. 2. When a soft-short-circuit occurs, the overall real resistance between the monitored and reference electrode decreases because the current flow faces less linear resistance because of the soft-short. Due to the reduced capacitive and inductive reactance, the exemplary system shows more of a linear resistive response than a reactive response but much less than the nominal impedance representation shown in a healthy state because of the soft sort-circuit. As a result, the position or location of the center (e.g., its midpoint) of the semi-circle like representation of impedance shifts left (e.g., its liner impedance is reduced) because of the battery's lower resistive value and the semi-circle like object's radius decreases (e.g., its reactive resistance decreases) due to the decrease in the battery's capacitive and inductive reactance that are detected by the monitor engine 714 at 212. The phrase “semi-circle like” refers to an object or feature having a larger arc portion joined to a significantly smaller arc portion at a possible inflection point without the smaller arc portion changing concavity (e.g., changing from a negative curvature or concave down representation to a positive curvature or concave up representation) as shown in FIGS. 4-6, for example.

In some prognostic systems, the monitored conditions and/or patterns occurring during onset intervals and onset training intervals that lie between a battery's healthy state and the battery's failure state reflect the changing length of the radius of the larger arc portion of the semi-circle like object representation and reflect the translation of the midpoint of the semi-circle like object representation. The onset radial interval and/or onset midpoint interval that lie between the battery's healthy operating state and the battery's failing operating state are established through empirical analysis. The empirical analysis differentiates a battery operating within its designed, expected, and/or optimal performance state and a battery experiencing failure (e.g., experience reduced capacity, voltage sags, swelling, and/or an overall decline). Once defined, the predictive learning models 716 are trained, validated, and executed by the model trainer and validator 728 to predict pre-failure battery conditions based on radial changes in complex impedance measurements and/or midpoint or center point translations in complex impedance plots or Nyquist plots. The term “radii” and “radius” with respect to the semi-circle like representations of impedance generally refers to a point that lies approximately halfway along the diameter of the larger arc portion of the semi-circle like object representation. The term “midpoint” and “center” generally refers to the linear impedance value that lies substantially halfway between the smallest and largest real impedance values of the semi-circle like object impedance representation.

For example, in FIG. 3 dash horizontal lines bound the radial unstable operating interval 302 when a battery transitions from a healthy operating state 304 to a failing operating state 306 caused by soft-shorts. In FIG. 4 the radial interval is conditioned by removing the outer margins shown as the shaded regions or intervals 402. The outer margins are the intervals that are directly adjacent the radius of the healthy operating state 304 within the unstable operating interval 302 and radius directly adjacent the radius of failing operating state 306 within the unstable operating interval 302. Once the intervals 402 are removed, the data within the intervals comprise the conditioned onset training intervals that are sampled and labeled by sampler 734 to render conditioned onset training data stored in memory 724. To minimize the effect of anomalies and transients that may be mistakenly detected and labeled as a failure state, data associated with disruptive events are excluded or filtered out from the conditioned onset training data and the filtered conditioned onset training data is then used to train the predictive learning models to detect onset intervals. Once trained, the predictive learning models 716 are evaluated using another portion of the filtered conditioned onset training data not used to train the predictive learning models 716 by the model trainer and validator 728. If the predictive learning models accurately predict an impending failure or a pre-failure state below a predetermined error rate, the trained predictive learning model 716 are executed by the predictive engine 730 to identify pre-failure states by detecting onset interval based on the lengths of radii of the complex impedance measurement at 212. If the predictive learning models do not accurately predict an impending failure or a pre-failure state below a predetermined error rate, the training continues or is repeated.

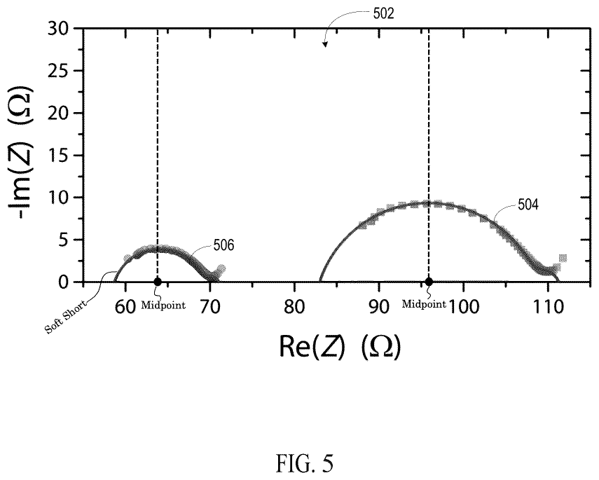

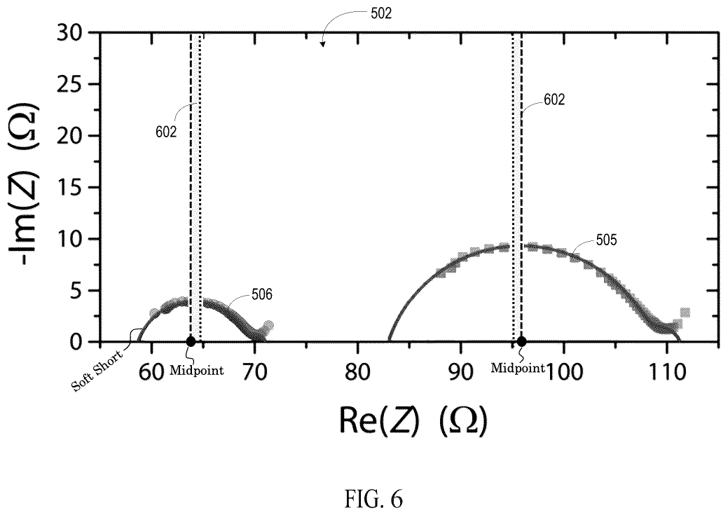

Similarly, the translations of the midpoints of complex impedance measurements identify impending battery failures and/or pre-failure states alone or in combination with the monitored radii. For example, in FIG. 5 the dashed vertical lines identify the boundaries of the unstable operating interval 502 when a battery transitions from a healthy operating state 504 to a failing operating state 506. In FIG. 6 the midpoint intervals are conditioned by shortening or removing the outer margins of the interval shown as the shaded regions our outer margins 602. The outer margins 602 are the intervals that are directly adjacent to the midpoints of the complex impedance measurement near the healthy operating state within the unstable operating interval 502 and the midpoints that are directly adjacent to the failing operating state within the unstable operating interval 502. The linear resistance interval between the removed intervals comprise the conditioned onset training intervals that are sampled and labeled by the sampler 734 to render conditioned onset training data stored in memory 724. To minimize the effect of anomalies and transients that may be mistakenly detected and labeled as a failure state, data associated with disruptive events are excluded or filtered out from the conditioned onset training data and the filtered conditioned onset training data is stored in memory 724 then processed to train the predictive learning models by the model trainer and validator 728. Once trained, the predictive learning models 716 are evaluated using another portion of the filtered conditioned onset training data that is not processed to train the predictive training models 716.

Once trained, the predictive learning models are evaluated using another portion of the filtered conditioned onset training data by the model trainer and validator 728. If the models accurately predict an impending failure or pre-failure state below a predetermined error rate, the trained predictive learning models are executed by the predictive engines 730 to identify pre-failure state through onset interval detections based on the midpoints of the real impedance measurement at 212. If the models do not accurately predict an impending failure or pre-failure state below a predetermined error rate, the training continues or is repeated. In alternative prognostic systems, impending battery failures and/or pre-failure conditions are predicted by analyzing both radial and midpoint changes in the complex impedance measurements through the predictive engine 730 at 212. Further, the prognostic systems may analyze and predict pre-failure states across one or multiple battery cells of one or multiple battery packs.

The prognostic system renders predictions through the predictive engine 730 when processing compatible data. In some systems, a trigger event initiates optional preventative measures described herein and represented at 214 and may initiate a communication to a remote user, site, or object via networks 720. These optional preventive measures include performing maintenance, scheduling maintenance, quarantining at risk batteries, executing predetermined conditioning, modifying the duration of a charging processes, executing load redistributions, executing isolation, reallocating battery resources, shedding loads, and/or executing other tasks that may follow the system's protocols and operating guidelines. Further, the optional preventive measures may include communicating alerts, status data and/or historical data to users, OEMs, charging infrastructure providers, insurer's and/or other users and third parties. In some systems, the processor 710 initiates the trigger event that the controller 708 and/or an optional load balancer 704 services by executing one or more preventative measures including isolating, rebalancing, and shedding loads.

FIG. 7 is a block diagram of a prognostic system that may execute the process flows and characteristics described herein and shown in FIGS. 1-6. The systems comprise a processor 710, a non-transitory memory 702 that can be read from and written to by the processor 710, a controller 708, one or more optional load balancers 704, an input and output interface 718, an optional transceiver 736, and one or more networks 720. The input and output interface 718 and the one or more networks 720 allow the prognostic systems to communicate with users, third parties, and remote destinations wirelessly or physically through intermediate objects. The non-transitory memory 702 causes the prognostic system to render some or all of the functionality associated with predicting pre-failure states such when a device is approaching an impending battery failure caused by dendrites about to pierce the separator that isolates an anode from a cathode in a device or one or more vehicle lithium batteries, for example. The non-transitory memory 702 stores instructions, which when executed by the processor 710 or signal processor interfaced to the monitored device 706, causes the prognostic system to render functionality associated with the database 722, the waveform or signal generator 712, the sampler 734, the voltage controller 732, the graphing software 738, the preventative measure processes 726, the memory shown as the training data warehouse 724, the predictive models 716, the model trainer and validator software 728, the predictive engine 730, and the monitor engine 714. In some prognostic systems, the non-transitory media 702 comprises local memory resident to local devices and/or local systems. In other prognostic systems, the non-transitory media comprises distributed storage and/or servers or a combination of local and distributed storage that in some systems include local permanent or transient memory. In these alternative prognostic systems a distributed network of servers and clouds deliver monitoring and forecasts closer to end-users, with less latency and faster load times. The distributed networks and clouds allows for the sharing of resources to ensure consistent monitoring across many devices located at many locations.

The distributed storage or non-transitory memory 702 and/or storage disclosed also retain an ordered listing of executable instructions for implementing the processes, system functions, and features described above in a non-transitory machine or computer readable code. The machine-readable medium may selectively be, but not limited to, an electronic, a magnetic, an optical, an electromagnetic, an infrared, or a semiconductor medium. A non-exhaustive list of examples of a machine-readable medium storage includes: a portable magnetic or optical disk, a volatile memory, such as a Random-Access Memory (RAM), a Read-Only Memory (ROM), an Erasable Programmable Read-Only Memory (EPROM) or a Flash memory, or a database management system. The cloud/cloud services and/or memory 702 may comprise a single device or multiple devices that may be disposed on one or more dedicated memory devices or disposed within one or more processors 710, customized circuit or another similar device. An “engine” may comprise a processor or a portion of a program that executes or supports pre-failure state predictions such as failure predictions of one or more batteries and/or battery cells. When functions, steps, etc. are “responsive to” or occur “in response to” another function or step, etc., the functions or steps necessarily occur as a result of another function or step, etc. A device or process that is responsive to another requires more than an action (i.e., the process and/or device's response to) merely follow another action. Further, the term “failure” generally refers to a battery, power source, or related device that does not operate reliably or operate within its designed specification.

In this disclosure the term “substantially” or “about” encompasses a range that is largely in some instances, but not necessarily wholly, that which is specified. It encompasses all but a significant amount, such as what is specified or within five to ten percent. In other words, the terms “substantially” or “about” means equal to or at or within five to ten percent of the expressed value. Forms of the term “cascade” and the term itself refer to an arrangement of two or more components such that the output of one component is the direct input of the next component (e.g., in a series connection). The term “unitary” refers to an indivisible entity, oneness, and singularity. It refers to a single indivisible entity or component.

The monitoring systems that render the disclosed functions herein may be practiced in the absence of any disclosed or expressed element (including the components, hardware, the software, and/or the functionality expressed), and in the absence of some or all of the described functions association with a process step or component or structure that are expressly described. The systems may operate in the absence of one or more of these components, process steps, elements and/or any subset of the expressed functions. Further, the systems may function with additional or substitute elements and functionality, too. For example, the components that control the voltage differences between the electrode of the monitored device and a reference electrode measuring current flow through the working electrode associated with specific frequencies may comprise a potentiostat in alternative prognostic systems.

Further, the various elements and system components, and process steps described in each of the many systems and processes described herein is regarded as divisible with regard to the individual elements described, rather than inseparable as a whole. In other words, alternate systems encompass any variation and combinations of elements, components, and process steps described herein and may be made, used, or executed without the various elements described (e.g., they may operate in the absence of) including some and all of those disclosed in the prior art but not expressed in the disclosure herein. Thus, some systems do not include those disclosed in the prior art including those not described herein and thus are described as not being part of those systems and/or components and thus rendering alternative systems that may be claimed as systems and/or methods excluding those elements and/or steps.

The disclosed prognostic systems are battery management systems in some applications that may be integrated with or are unitary part of other electrical systems, detectors, sensors, vehicles, charging systems, and analytical instrumentation. In charging systems, the battery management system combines a complex alternating signal and a charging signal during the initial phase of a charging cycle. A monitoring engine 714 monitors the battery response to the complex composite signal. The response is analyzed to detect changes in impedance, and in alternate systems, also other electrical characteristics indicating an impending battery failure or a pre-failure state. In response to these identifications, the battery management system may alert local and remote users, third parties, and tracking systems to mitigate or prevent one or more battery or battery cell failures. The analysis may detect the formation of lithium dendrites in a lithium based electrolyte battery and/or other rechargeable charge delivery systems. Further, in some applications the battery management systems may schedule maintenance, lower the charging rate during a charging processes, increasing the charging periods (e.g., move a charging program from level 3 to level 2), isolate deteriorating batteries and/or cells, initiate, schedule or adjust battery maintenance/schedules.

The prognostic systems that comprise part of some battery operating systems generate models by training on data collected well before a battery fails and data from periods preceding failures within a conditioned onset interval. This approach allows the systems to guard against both known (e.g., dendrite induced sort-circuits) and unknown causes of battery failures by detecting onset periods based on one or more criteria. As a result the systems can prevent battery failures without detecting and identifying causes.

Other systems, methods, features, and advantages will be, or will become, apparent to one with skill in the art upon examination of the figures and detailed description. It is intended that all such additional systems, methods, features, and advantages be included within this description, be within the scope of the disclosure, and be protected by the following claims.

1. A battery management system comprising:
a signal generator that synthesizes a variable power signal by mixing three or more fundamental frequencies distributed over at least three decades and overlapping the three or more fundamental frequencies through a predetermined bias;
an input/output circuit electrically that couples the signal generator with a single battery cell or a plurality of battery cells to inject the variable power signal and a charging signal into the single battery cell or the plurality of battery cells;
a monitor engine that repeatedly measures a voltage at, and a current through, the single battery cell or the plurality of battery cells in response to the injection of the variable power signal; and
a processor that
monitors spectral data associated with the single battery cell or the plurality of battery cells to identify an onset interval that identifies a pre-failure state of the single battery cell or the plurality of battery cells in response to an injection of the variable power signal and the charging signal into the single battery cell or the plurality of battery cells,
repeatedly derives impedance levels for the single battery cell or the plurality of battery cells, and
identifies a short-circuit condition in response to a detection of the onset interval.

2. The system of claim 1, wherein the processor
processes a plurality of representations of a frequency spectrum of an impedance of the single battery cell or the plurality of battery cells by generating a plurality of arcs on a Nyquist plot,
monitors whether a condition of a radius associated with at least one of the plurality of arcs lie within an onset interval, and
transmits a message when the condition occurs.

3. The system of claim 1, wherein the signal generator synthesizes the variable power signal by a mixing of three to one-hundred fundamental frequencies.

4. The system of claim 1, wherein the signal generator generates a frequency range of about one one-hundredth hertz to about one-hundred kilohertz.

5. The system of claim 1, wherein the single battery cell or the plurality of battery cells comprise a Li-based electrolyte comprised of a Li metal or a Li ion.

6. The system of claim 1, wherein the system is disposed within a motorized vehicle and detects a Li dendrite formation in the single battery cell or the plurality of battery cells within the motorized vehicle.

7. The system of claim 1, wherein the system is disposed within a portable device and detects a Li dendrite formation in the single battery cell or the plurality of battery cells that power the portable device.

8. A method of managing a battery system comprising:
identifying data indicative of a potential battery cell failure or a potential battery failure during a battery charging cycle without identifying an originating cause of the potential battery cell failure or the potential battery failure;
identifying an unstable operating interval of a battery cell or a battery that lies between a battery's healthy operating state and a battery's failing operating state;
labeling data within the unstable operating interval of the battery cell or the battery that identify a battery cell's operating conditions or the battery's operating conditions to generate a battery profile;
training a predictive model by training on a portion of the battery profile that represents an interval that follows a normal operating battery state and precedes an impending battery failure to render a trained predictive model;
executing the trained predictive model by a predictive engine during the charging cycle by injecting a synthesized alternating current into a direct charging current that recharges the battery cell or recharges the battery; and
executing one or more preventive measures in response to a prediction of the potential battery cell failure or the potential battery failure by the predictive engine monitoring the battery cell or the battery.

9. The method of claim 8 where the battery profile is associated with a soft-short-circuit condition occurring during the battery cell's charging cycle or the battery's charging cycle.

10. The method of claim 8 where the battery profile reflects a battery cell's internal impedance or a battery's internal impedance during the battery cell charging cycle or the battery's charging cycle.

11. The method of claim 10 where the predictive model trains on labeled data indicative of a plurality of radii representative of the battery cell's internal impedance or the battery's internal impedance during the battery cell charging cycle or the battery's charging cycle.

12. The method of claim 10 where the predictive model trains on labeled data indicative of a plurality of linear resistance midpoints representative of the battery cell's internal impedance or the battery internal impedance during the battery cell charging cycle or the battery's charging cycle.

13. The method of claim 10 where the predictive model trains on labeled data indicative of a plurality of linear resistance midpoints and a plurality of radii representative of the battery cell internal impedance or the battery's internal impedance during the battery cell charging cycle or the battery's charging cycle.

14. The method of any of claim 8 where the predictive model trains on labeled data indicative of a normal condition and indicative of a conditioned onset interval.

15. The method of any of claim 8 where the predictive model trains on labeled data indicative of a normal condition and indicative of a filtered conditioned onset interval.

16. The method of claim 8 further comprising synthesizing a complex alternating current injected into a direct current during a charging cycle of the battery cell or the battery to render the unstable operating interval of the battery cell or the battery.

17. The method of claim 8 where the unstable operating interval of the battery cell or the battery is determined from a semi-circle like object impedance representation of the battery cell or the battery.

18. A computer readable medium storing a program in a non-transitory media that manages a battery system by identifying short-circuits during a recharging cycle when executed by a processor by:
identifying data indicative of a potential battery cell failure or a potential battery failure during a battery charging cycle without identifying an originating cause of the potential battery cell failure or the potential battery failure;
identifying an unstable operating interval of a battery cell or a battery that lies between a battery's cells healthy operating state or a battery's healthy operating state and a battery's cells failing operating state or a battery's failing operating state;
labeling data within the unstable operating interval of the battery cell or the battery that identify a battery cell's operating conditions or a battery's operating conditions to render a battery profile;
training a predictive model by sampling a portion of the battery profile that represents data that follow a normal operating battery state and occurs before an imminent battery failure state to render a trained predictive model;
executing the trained predictive model by a predictive engine during the battery charging cycle by injecting a synthesized alternating current into a direct charging current that recharges the battery cell or recharges the battery; and
executing one or more preventive measures in response to a prediction of the potential battery cell failure or a prediction of the potential battery failure by the predictive engine monitoring the battery cell or the battery.

19. The computer readable medium of claim 18 where the one or more preventive measures comprise transmitting data to a remote site.

20. The computer readable medium of claim 18 where the one or more preventive measures comprise scheduling maintenance in response to the prediction of the potential battery cell failure or the prediction of the potential battery failure.

21. The computer readable medium of claim 18 where the one or more preventive measures comprise initiating a load rebalancing of a battery in response to the prediction of the potential battery cell failure or the prediction of the potential battery failure.

22. The computer readable medium of claim 18 where the computer readable medium is a unitary part of a vehicle system.

23. The computer readable medium of claim 18 where the computer readable medium is integrated in an electric vehicle charging infrastructure.

24. The computer readable medium of claim 18 where the computer readable medium is integrated in a portable electronic device.

25. The computer readable medium of claim 18 where the computer readable medium is integrated in a charging station.
